(19) United States
(12) Patent Application Publication
(10) Pub. No.: US 2003/0185350 A1
(43) Pub. Date: Oct. 2, 2003

(54) Method for matching the ocupancy states between a terminal and a switching facility, and a corresponding switching facility and a monitoring program

(76) Inventor: Thomas Plarre, Holzkirchen (DE)

Correspondence Address: MORRISON & FOERSTER LLP, 1650 TYSONS BOULEVARD, SUITE 300, MCLEAN, VA, 22102, US

(21) Appl. No.: 10/221,343

(22) PCT Filed: Sep. 3, 2001
(86) PCT No.: PCT/DE01/03372

(30) Foreign Application Priority Data
Sep. 8, 2000 (DE) 10044434.2

(51) Int. Cl. H04M 1/24; H04M 3/22; H04M 3/08

(52) U.S. Cl. 379/15.01; 379/28; 379/32.01

(57) ABSTRACT

The invention relates to a method, according to which, tasks arriving from a switching facility (12) or from another location are accepted by a terminal (14), in particular, in the framework of a call distribution. A change of the occupancy state of the terminal (14) is effected upon the attainment and falling below of a predetermined number of tasks to be simultaneously processed. The change is noted in the switching facility (12) and in the terminal (14). The flawless execution of the change of the occupancy state is automatically monitored by a program located on the side of the terminal (14).

The invention relates to a method in which a switching facility connects a communication network and/or a data transmission network to at least one terminal, to which tasks are assigned by the switching facility. However, the terminal also processes tasks arriving from another place than the switching facility, e.g., from an operator or from a local data transmission network. The terminal can only complete a specified number of tasks simultaneously, e.g., only one task. If the specified number is reached and not reached, the-occupancy state of the device is changed. For example, there are the occupancy states “clear” and “busy.” If the occupancy state is changed, actions are initiated to note the change in the occupancy state in the switching facility and/or in the terminal. The faultless execution of these actions is monitored automatically.

The switching facility is, for example, a telecommunications installation, used to establish connections within the premises of a government agency or of a company. For example, telecommunication systems of the type HICOM from Siemens AG are used. However, a switching center of the public telephone network is also used, e.g., a switching center of the type EWSD from Siemens. In particular, switching centers that take over the function of a telecommunications facility are used. The terminal is, e.g., a computer having an ISDN card (integrated services digital network) and possibly also having a network card, through which the computer is connected to a local data network. However, digital telephones, which are connected to the telecommunications installation but not to the data transmission network, are also used. The communication network is, for example, the public telephone network or a cellular network. The data transmission network is, for example, the Internet or a local data network.

A known method to monitor the occupancy state is to perform audits in the switching facility at set time intervals, e.g., every 15 minutes. In performing the audits, the occupancy states of all terminals are then queried and compared with the occupancy states noted in the switching facility and corrected if necessary. Using the audit, however, it is not possible to eliminate deviations of the occupancy states rapidly enough.

The object of the invention is to specify a simple method to balance occupancy states, which makes rapid correction possible. In addition, an associated switching facility and an associated monitoring program are to be specified. The objective relating to the method will be achieved by the procedural steps specified in claim 1. Enhancements are specified in the dependent claims.

The invention proceeds from the consideration that considerable computing time is necessary in the switching facility to check all connected terminals. Because of this computing time, it is not possible to shorten the time between two successive checks relating to a terminal as desired, even if the check is interrupted in the meantime. If, however, the terminals themselves perform the check, the switching facility is subjected to a substantially smaller load by the audit. Besides, sufficient computing time is available in the terminals. Therefore, the monitoring is performed in the terminal in the method of the present invention. This action ensures that the time between the check of a terminal and the next check of such terminal is substantially reduced without blocking the switching facility.

Deviations of the occupancy states between the terminal and the switching facility may thus be determined and also rapidly corrected. The time in which an occupiable terminal may not be occupied when an occupancy request is made for a terminal is shortened.

In an enhancement, the monitoring is started as a function of not reaching the specified number. Thus a specific time interval is not used as a starting time for the monitoring procedure but instead the release of the terminal. This has the advantage that the occupancy states are checked at a point in time at which the terminal is not occupied. The terminal may thus perform its actual tasks undisturbed by the monitoring. Since the state of the terminal is known at the time of the monitoring process, the monitoring is simplified.

In a next enhancement, the switching facility distributes calls arriving under one number or under one address to one of several terminals, e.g., cyclically. The switching facility and the terminals thus make up a distribution system. Such distribution systems are identified, for example, as call centers. In distribution systems, it is of particular importance that no occupiable terminals stay unoccupied because the number of tasks processed or requests is otherwise noticeably reduced. This applies in particular at heavy traffic periods in which all terminals are occupied. If, for example, five terminals are connected and one terminal stays unoccupied although it could actually be occupied, the number of tasks processed by the distribution system is reduced by 20 percent.

In a next enhancement, a first time period is started at the beginning of the monitoring in connection with a short-term monitoring. The time period amounts to several seconds, e.g., three seconds. If the terminal is occupied during the first time period, the monitoring is interrupted. Only at the end of the first time period are additional steps taken in connection with the monitoring. These steps include, for example, error handling. The result of this action is that the monitoring is not carried out until it is ensured that no heavy traffic period is present. In a heavy traffic period, the terminal is reoccupied before the end of the first time period. In addition, the occupancy ensures that the terminal does not stay unused. Thus monitoring is superfluous during an occupancy within the first time period. This applies both to an occupancy sent by the switching facility as well as an occupancy sent by another place, e.g., an occupancy initiated by the operator of the terminal.

In a next enhancement, the occupancy state noted in the switching facility is sent to the terminal at the end of the first time period. This is preferably done upon a query by the terminal to the switching facility. The state transmitted by the switching facility is checked by comparing, for example, an occupancy state noted in the terminal with the transmitted occupancy state. If the transmitted occupancy state deviates from the occupancy state of the terminal, additional steps in connection with the monitoring are carried out. If the transmitted occupancy state and the occupancy state of the terminal agree, the monitoring is interrupted. As an alternative, however, other steps may be carried out in connection with the monitoring. Accordingly, short-term monitoring is switched to long-term monitoring. When the occupancy state is transmitted, only a minor load is placed on the switching facility because it is only necessary to reply to a corresponding message. The occupancy state is checked on the terminal side.

In one embodiment, error handling is started if the transmitted occupancy state deviates from the occupancy state of the terminal. As an alternative, however, at least one second time period is started in connection with the short-term monitoring, the second time period preferably being in the seconds range. If the terminal is occupied during the second time period, the monitoring is interrupted. The error handling is carried out at the end of the last of the second time periods. The embodiment makes it possible to consider delay times when changing the occupancy states in the switching facility. Although the switching facility transmitted a deviating, i.e., incorrect, occupancy state, it is possible that a correct occupancy state was noted in the switching facility in the meantime. If the switching facility occupies the terminal again based on the correct occupancy state, i.e., “clear,” the error handling is stopped.

In another embodiment, at the end of a second time period, which is not the last second time period, the occupancy state noted in the switching facility is again transmitted to the terminal. The transmitted occupancy state is in turn checked. Depending on the result of the check, the process steps already mentioned above relative to the result of the check are carried out. This action, makes it possible to ensure that delay times are also considered in the switching facility if the switching facility does not immediately establish a new occupancy. In the second or third query of the occupancy state in the switching facility, the notation for the occupancy state may actually already have been updated. In this case, it is possible to avoid unnecessary actions for error handling.

In a next enhancement, if the transmitted occupancy state and the occupancy state of the terminal agree in connection with a long-term monitoring, a third time period is started which is longer than the first time period and preferably is in the minutes range. If the terminal is occupied during the third time period, the monitoring is stopped. At the end of the third time period, the occupancy state noted in the switching facility is transmitted to the terminal. The transmitted occupancy state is checked. Depending on the result of the check, the process states explained above, which refer to the check result, are carried out. In particular, when a deviation is detected between the occupancy states, a switch is made from long-term monitoring to short-term monitoring. During the long-term monitoring, fewer reports are exchanged between the terminal and switching facility per time unit than during the short-term monitoring.

In another enhancement, the actions to note the change in the switching facility are repeated in connection with the error handling. For example, the terminal again transmits messages to change the status. As an alternative, the occupancy state of the terminal may be adapted to the occupancy state noted in the switching facility. For that purpose, the occupancy state transmitted by the switching facility in connection with the monitoring may be used.

The invention also relates to a terminal which is suitable to implement the method of the present invention or one of its enhancements. Thus the effects cited above for the method also apply to the terminal. In particular, the monitoring in the terminal is started as a function of not reaching the specified number of tasks to be performed simultaneously.

Furthermore, the invention relates to a monitoring program containing an instruction sequence, such that being executed by a processor, the procedural steps relating to the monitoring are carried out according to the method of the present invention or one of its enhancements. Consequently, the technical effects cited above also apply to the monitoring program.

Exemplary embodiments of the invention will be explained below with reference to the appended drawings, in which:

FIG. 1 shows a task distribution system,

FIGS. 2A to 2C show scenarios for balancing occupancy states in a terminal and a telecommunications installation,

FIGS. 3A and 3B show process steps for executing a monitoring program in the terminal and

FIGS. 4A to 4D show scenarios for monitoring the occupancy states in the terminal and the telecommunications installation.

FIG. 1 shows a task distribution system 10 containing a telecommunications installation 12, terminals 14 and 16 as well as a service provider computer 18. The functions of the telecommunications installation 12 are performed by a switching center of type EWSD from Siemens AG. The telecommunications installation contains functions for the distribution of tasks. A task distribution program 20 performs these functions. The telecommunications installation 12 is connected to both the public telephone network and to the Internet. There are also connecting lines 22 and 24 to terminals 14 and 16, respectively. For example, the manufacturer of the telecommunications installation 12 is signaled on connecting lines 22 and 24 according to a company-owned protocol. This protocol may be based on Digital Signaling System One (DSSI), the standardized protocol for subscriber signaling.

The task distribution program 20 accepts incoming calls from the telecommunications network and distributes them to one of terminals 14 and 16. IP (Internet Protocol) calls coming from the Internet and e-mails are also transmitted to terminals 14, 16. The service provider computer 18 connected using a connecting line 26 and a local data transmission network 28 are included.

However, the task distribution program 20 distributes only such tasks that arrive at the telecommunications installation 12 under a predetermined subscriber number or under a predetermined Internet address. The tasks may only be distributed to such terminals 14 and 16 that are not occupied at the time. A status management program 30 makes it possible to determine clear terminals 14 and 16 from the telecommunications installation 12.

The terminals 14 and 16 are computers, each having a speaker and a microphone as well as a speech processing unit. Both terminals 14 and 16 are connected to the local data transmission network 28. The terminals 14 and 16 are also designated as so-called agent workstations. This is particularly the case when the terminals 14 and 16 are used for task distribution. Task distribution may be carried out according to international standards. Thus a method is used for call distribution, which meets Standard CSTA (Services for Computer Supported Telecommunications Applications) Phase III of ECMA (European Computer Manufacturer Association).

FIGS. 2A to 2C show scenarios for balancing occupancy states between the terminal 14 and the telecommunications installation 12. Changes in the occupancy states originate from both the terminal 14 and the telecommunications installation 12. For that reason, a synchronization of the occupancy state is necessary. On the side of the telecommunications installation 12, the status management program 30 shown in FIG. 1 is used to synchronize the occupancy state.

FIG. 2A shows an implicit change of the occupancy states by the exchange of messages M. It may be assumed that the telecommunications installation 12 transmits a message 50 to the terminal 14 at point in time t0. For example, the message 50 is used to signal an incoming call to the terminal 14. The message 50 arrives at the terminal 14 at a point in time ti. In the telecommunications installation 12, the occupancy state of the terminal 14 noted there when the message 50 is sent is automatically changed to the condition “busy” (see Frame 52). When the message 50 is received in the terminal 14, the noted and the actual occupancy state of the terminal 14 is also automatically changed to the state “busy” in the terminal device 14, as this is necessary for the processing of a call request (see Frame 54).

On the other hand, an implicit change of occupancy states is also carried out if the terminal 14 sends a message 56 to the telecommunications installation 12 at a point in time t2 in connection with the task control. For example, the message 56 contains a call setup request because the subscriber using the terminal 14 would like to set up a call. The message 56 arrives in the telecommunications installation 12 at a point in time t3. Based on the message 56, the occupancy state of the terminal is identified automatically as “busy” in the telecommunications installation 12 because the terminal 14 is only able to set up one call (see frame 58. The occupancy state is also noted as “busy” in the terminal 14 while the message 56 is being sent (see frame 60.

If the transmission of the message 50 or the transmission of the message 56 is interfered with, see interference arrows 62 and 64, there is a deviation of the occupancy states for the terminal 14 noted in the terminal 14 and in the telecommunications installation 12. In order to correct such deviations, the procedures explained with reference to FIGS. 3A, 3B and 4A to 4D are carried out.

FIG. 2B shows the explicit change of occupancy states by the exchange of unprotected messages M. At a point in time t0, the telecommunications installation 12 sends an unprotected status message 80 to the terminal 14. Status message 80 contains a request to change the occupancy state to the state “clear” or to the state “busy.” Status message 80 arrives in the terminal 14 at a point in time t1a. When status message 80 is sent, the new occupancy state is noted in the telecommunications installation (see frame 82. After status message 80 is received in the terminal 14, the new occupancy state is also noted in the terminal 14 (see frame 84.

On the other hand, the terminal 14 also sends unprotected messages M to the telecommunications installation 12 for status change, as is the case with a status message 86 transferred at a point in time t2a. Status message 86 is received in the telecommunications installation 12 at a point in time t3a. When status message 86 is sent, the new occupancy state is noted in the terminal 14 (see frame 88). After status message 86 is received in the telecommunications installation 12, the new status according to status message 86 is also noted in the telecommunications installation 12 (see frame 90).

If there is interference during the transmission of status messages 80 or 86 (see interference arrows 92 and 94), the result is deviations in the noted occupancy states in terminal 14 or in the telecommunications installation 12. Such deviations result in restricted use of the terminal 14. To eliminate such deviations the procedural steps explained with reference to FIGS. 3A, 3B and 4A to 4D are carried out.

FIG. 2C shows explicit changes in the occupancy states brought about by the exchange of protected messages M. At a point in time t0b, the telecommunications installation 12 sends a status message 100 to the terminal 14. Status message 100 is received in the terminal 14 at a point in time t1b. For example, the state “clear” is noted in status message 100 as a new occupancy state. When status message 100 is processed in the terminal 14, the occupancy state noted in the terminal 14 is set to a value for the state “clear” (see frame 102). Because status message 100 requests a confirmation message, the terminal 14 sends an associated confirmation message 104 to the telecommunications installation 12 at a point in time t2b. The confirmation message 104 arrives in the telecommunications installation 12 at a point in time t3b. Only after point in time t3b is the occupancy state of the terminal 14 noted as “clear” in the telecommunications installation 12 (see frame 106). This procedure ensures that the noted occupancy state of the terminal 14 is not changed in the telecommunications installation 12 until it is certain that the terminal 14 has also received status message 100. However, if there is interference (see interference arrows 108 and 110), there may nonetheless be deviations of the occupancy states.

If, on the other hand, the terminal 14 sends a status message 112 at a point in time t4b, which requests a confirmation, similar steps are then carried out. Status message 112 arrives in the telecommunications installation 12 at a point in time t5b. When status message 112 is processed, the occupancy state of the terminal 14 is newly noted in the telecommunications installation 12 (see frame 113). The telecommunications installation 12 then sends a confirmation message 114 to the terminal 14 at a point in time t6b in connection with processing status message 112. The confirmation message 114 arrives at the terminal 14 at a point in time t7b. Based on the confirmation message 114, the occupancy state in the terminal 14 is newly noted (see frame 116). Interference in the transmission of status message 112 or the confirmation message 114 (see interference arrows 118 and 120), results in deviations of the noted occupancy states in the terminal 14 and of the telecommunications installation 12. The deviations caused by the interference are eliminated using the procedures explained with reference to FIGS. 3A, 3B and 4A to 4C.

FIGS. 3A and 3B show procedural steps in executing a monitoring program in the terminal 14 (see FIG. 1). The process starts in a procedural step 150 with the release of the terminal 14. A note variable MV has the value zero at the start of the process.

In a following procedural step 152, a timer Z1 is started in connection with a short-term monitoring, the timer expiring in three seconds if it is not interrupted. In a procedural step 154, the monitoring program waits for an event. If, during the wait, the terminal 14 is occupied in a procedural step 156, timer Z1 is stopped in a procedural step 158. The occupancy of the terminal is processed in a procedural step 160. The monitoring is only started again after the processing of the occupancy is concluded, i.e., when the terminal is released.

If, however, while waiting for the event, an event occurs in a procedural step 154, which reports the expiration of timer Z1, procedural step 154 is followed by a procedural step 162. For example, if timer Z1 expires, an interruption is triggered that brings about the event “Z1 expired.”

Procedural step 162 is followed by a procedural step 164 in which the terminal 14 sends a status query to the telecommunications installation 12. In a procedural step 166, the monitoring program then waits for the reply from the telecommunications installation 12. This reply arrives in a procedural step 168.

In a following procedural step 170, the terminal 14 checks if the occupancy state contained in the reply matches the occupancy state noted for the terminal 14. If the occupancy states deviate from each other, procedural step 170 is followed by a procedural step 172 in which the note variable is increased by the value one. In a subsequent procedural step 174, a timer Z2 is also started in connection with the short-term monitoring. Timer Z2 also expires after three seconds.

In a procedural step 176, the monitoring program waits for an event to take place. If, during the waiting, the terminal 14 is occupied in a procedural step 178 before timer Z2 has expired, a procedural step 180 follows in which timer Z2 is stopped. Subsequently, the occupancy is processed in a procedural step 182. Only after the occupancy is processed, i.e., when the terminal 14 is released, is the monitoring program restarted (see procedural step 150).

If, however, during the waiting for an event, an event occurs in procedural step 176 that reports the expiration of timer Z2 (see procedural step 184), procedural step 184 is followed by a procedural step 186. In procedural step 186, it is checked if note variable MV already has the value two or a different specified value. If this is not the case, procedural step 186 is again immediately followed by procedural step 172. The process is now in a processing loop made up of procedural steps 172, 174, 176, 184 and 186. This loop is only departed from if occupancy of the terminal 14 occurs (see procedural step 178), or if it is determined in procedural step 186 that note variable MV has the value two. If note variable MV has the value two, procedural step 186 is immediately followed by a procedural step 188.

The status in the telecommunications installation 12 is changed in procedural step 188. For that purpose, the terminal 14 sends a status change message to the telecommunications installation 12. The process is ended in a following procedural step 190. As an alternative, however, the monitoring program many be restarted (see procedural step 150).

If it is determined in procedural step 170 that the occupancy state transmitted by the telecommunications installation 12 and the occupancy state noted in the terminal 14 are equal, procedural step 170 is immediately followed by a procedural step 192. In procedural step 192, a timer Z3 is started which expires after two minutes if it is not interrupted in the meantime.

The monitoring program awaits the occurrence of an event in a procedural step 194. If the terminal 14 is occupied before timer Z3 expires, see procedural step 196, timer z3 is stopped in a procedural step 198. The occupancy is processed in a following procedural step 200. Only after the terminal 14 is released again, is the monitoring program restarted (see procedural step 150).

If, however, an event that reports the expiration of timer Z3 occurs in procedural step 194 during the wait (see procedural step 202), procedural step 202 is again immediately followed by procedural step 164. The process is now in a loop made up of procedural steps 164 to 170 and 192 to 202. This means that the long-term monitoring has again changed to short-term monitoring.

The loop made up of procedural steps 164 to 170 and 192 to 202 is departed from either in procedural step 170 if deviations of the occupancy state are determined or if the terminal 14 is occupied (see procedural steps 178 and 196).

In another exemplary embodiment, procedural step 186 is again followed by procedural step 164 if note variable MV has still not reached the value two. It is achieved that the telecommunications installation 12 is repeatedly queried concerning the occupancy of the terminal 14, also in connection with the short-term monitoring.

The program explained with reference to FIGS. 3A and 3B may, for example, be executed using the Windows NT operating system from Microsoft GmbH. The Windows NT operating system makes the waiting conditions in procedural steps 154, 176 and 194 possible. Instead of timers Z1 to Z3, counter programs that run parallel to the monitoring program may also be used. Such a parallel execution of programs may also be implemented with the Windows NT operating system.

FIGS. 4A to 4D show scenarios for monitoring the occupancy states in the terminal 14 and the telecommunications installation 12. These measures make it possible to maintain the synchronicity of the occupancy states in the telecommunications installation 12 and in the terminal 14 even in the event of a message loss between the telecommunications installation 12 and the terminal 14 or in the case of other irregularities.

FIG. 4A shows the periodic checking of the occupancy state of the telecommunications installation 12. After a period m1, e.g., after 15 minutes (see frame 221), the occupancy state of the terminal 14 is queried using status query message 220 in connection with an audit. The terminal 14 reads its occupancy state and transmits a status message 222 to the telecommunications installation 12. If there is no deviation between the occupancy states, period ml is restarted (see frame 224). If, however, a deviation of the occupancy states is detected, a period m2 of, for example, three seconds is started (see frame 226). At the end of period m2, the telecommunications installation 12 again sends a status query message 228 to the terminal 14 (see frame 227. The terminal 14 replies to status query message 228 with a status message 230 in which the current occupancy state is noted. The telecommunications installation 12 again checks the occupancy states. If there is still a deviation, period m2 is started several times before error handling is carried out. In another exemplary embodiment, error handling is carried out immediately if a deviation of the occupancy states is detected in the telecommunications installation 12.

FIG. 4B shows another representation of the procedural steps already explained with reference to FIGS. 3A and 3B. After the terminal 14 is released, the monitoring program is started. After timer Z1 expires in procedural step 162, the terminal 14 sends a status query message 250 to the telecommunications installation 12. The telecommunications installation 12 replies with a status message 252. The terminal 14 compares the occupancy state transmitted by the telecommunications installation 12 with the occupancy state noted in the terminal 14. If the occupancy states are different from each other, timer Z2 is started, see procedural step 174. If, however, the occupancy states are equal, long-term monitoring is started (see frame 254. The procedural steps executed in the long-term monitoring are partly shown below with reference to FIG. 4C. In other respects, refer to FIGS. 3A and 3B.

If period Z2 expires, see procedural step 184, the terminal 14 again sends a status query message 256 to the telecommunications installation 12, see also procedural step 164 in FIG. 3A. The telecommunications installation 12 replies with a status message 258 in which the occupancy state of the terminal 14 is noted in the telecommunications installation 12. After t number of repetitions of period Z2, the occupancy state is corrected in the terminal 14 (see frame 260 and procedural step 188 in FIG. 3B.

FIG. 4C shows the long-term monitoring of the terminal 14. If timer Z3 expires in procedural step 202, the terminal 14 sends a status query message 270 to the telecommunications installation 12. While processing status query message 270, the telecommunications installation 12 reads a memory cell in which the occupancy state of the terminal 14 is noted. The read datum is then transmitted to the terminal 14 in a status message 272. In the terminal 14, the occupancy states are checked (see procedural step 170 in FIG. 3A). In the event of an error, note variable MV is reset to the value zero. The short-term monitoring is then started (see frame 274). In one exemplary embodiment, the start is made with procedural step 150. In another exemplary embodiment, the start is made with procedural step 172, as explained with reference to FIGS. 3A and 3B. If the occupancy states are equal, long-term monitoring is continued in procedural step 192.

FIG. 4D shows a further scenario for monitoring the occupancy states in the terminal 14 and in the telecommunications installation 12. In order to avoid deviations of the occupancy states, even with protected messages, an additional timer Z4 is used. After the terminal 14 has sent a status message 300, a timer Z4 is started in the terminal 14, which expires after a short time, e.g., after three seconds. A frame 302 illustrates the starting of timer Z4. If there is interference 304 when transmitting status message 300, timer Z4 then expires without a confirmation message being received by the telecommunications installation 12 in the meantime (see frame 306). After timer Z4 in the terminal 14 expires, a procedure for error handling is started. For example, the transmission of the status message is repeated.

### Drawing Translations

FIG. 1

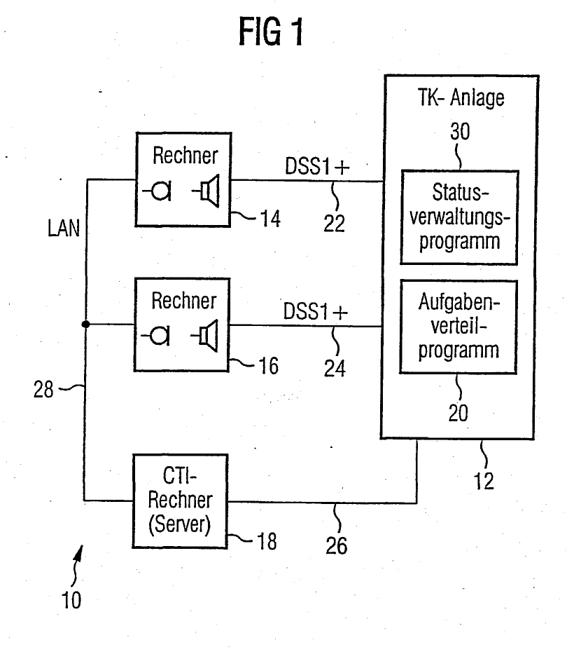

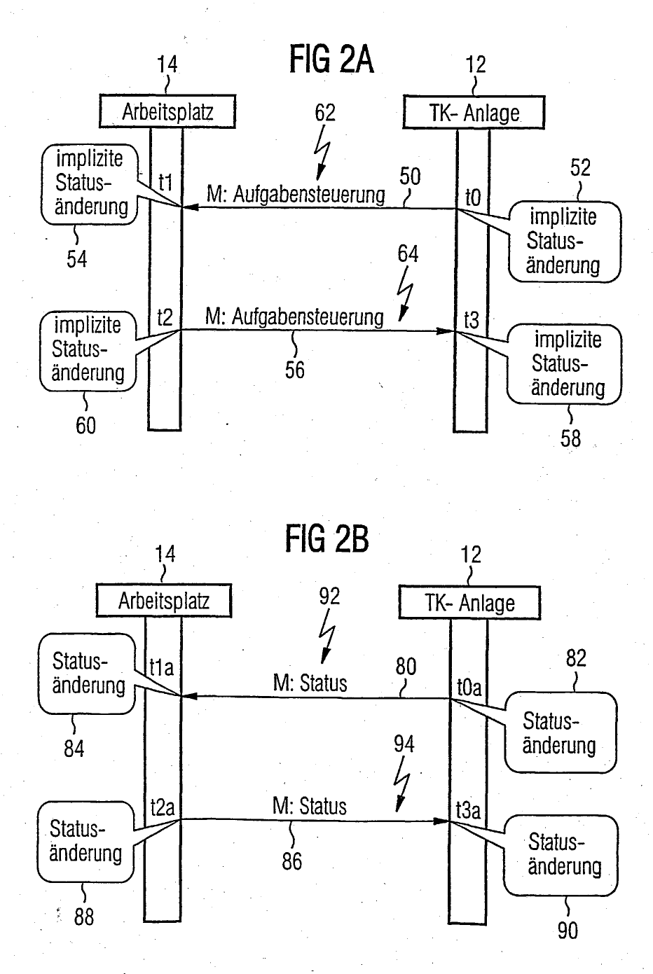

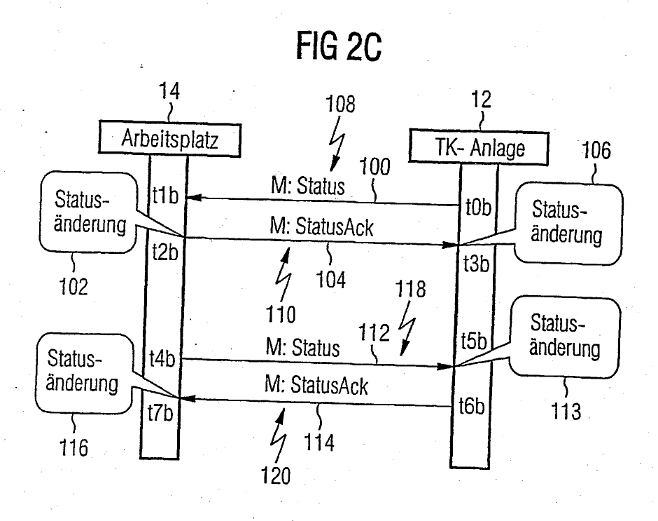

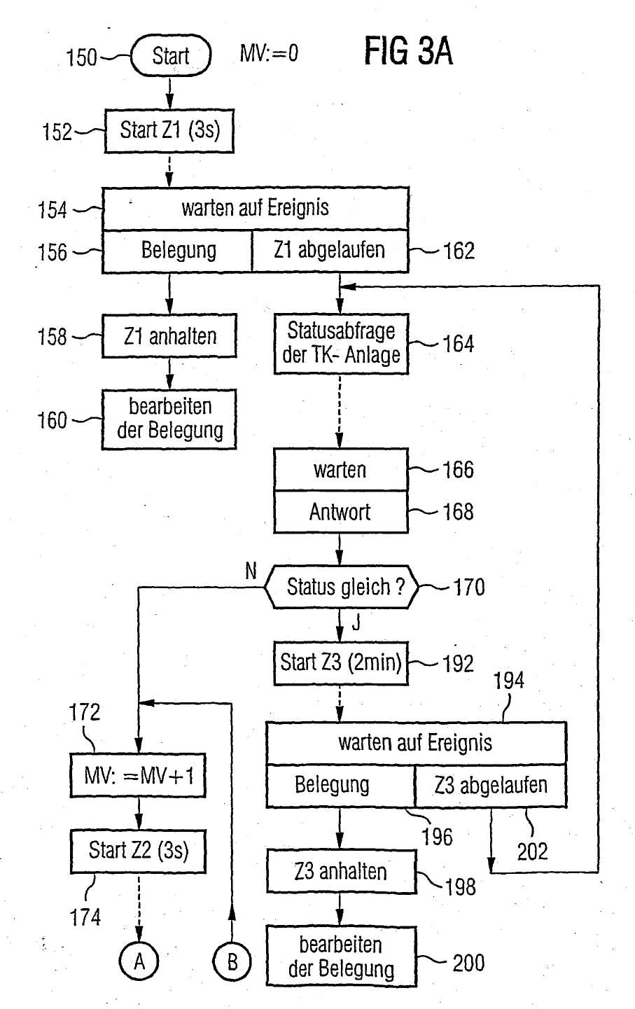

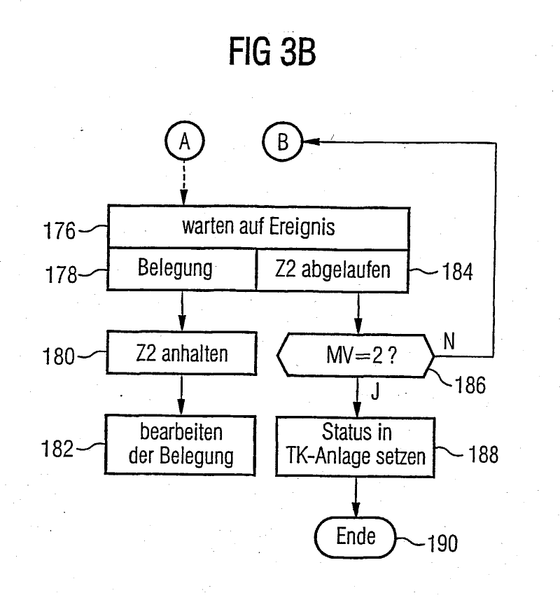

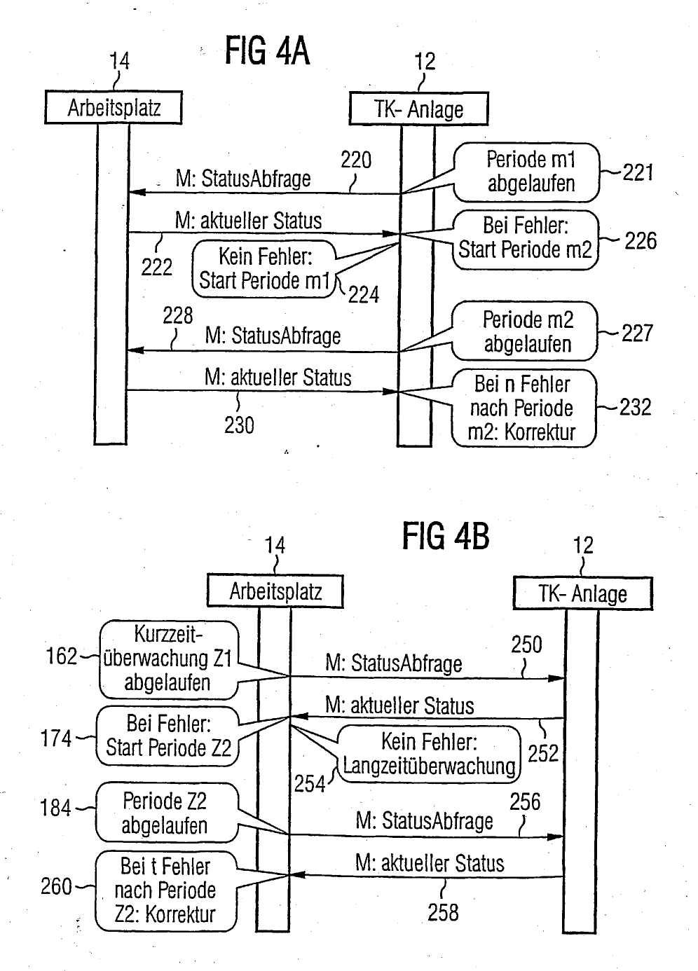

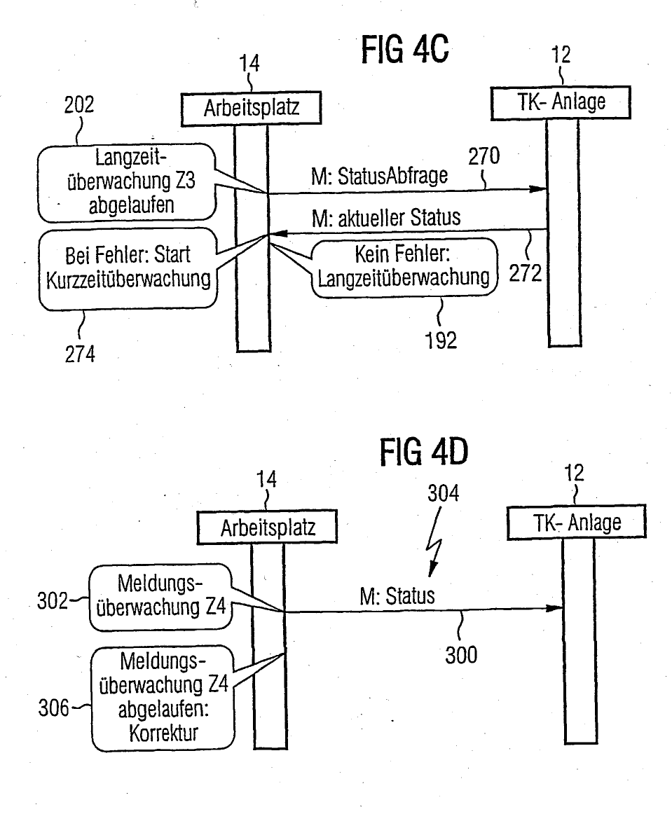

12 Telecommunications installation

14 Computer

16 Computer

18 CTI computer (server)

20 Task distribution program

22 DSS1+

24 DSS1+

30 Status administration program

### Drawing Translations

FIG. 2A

12 Telecommunications installation

14 Workstation

50 M: Task control

52 Implicit status change

54 Implicit status change

56 M: Task control

58 Implicit status change

60 Implicit status change

FIG. 2B

12 Telecommunications installation

14 Workstation

80 M: Status

82 Status change

84 Status change

86 M: Status

88 Status change

90 Status change

### Drawing Translations

FIG. 2C

12 Telecommunications installation

14 Workstation

100 M: Status

102 Status change

104 M: StatusAck

106 Status change

112 M: Status

113 Status change

114 M: StatusAck

116 Status change

### Drawing Translations

FIG. 3A

150 Start

152 Start Z1 (3 s)

154 Wait for event

156 Occupancy

158 Stop Z1

160 Processing the occupancy

162 Z1 expired

164 Status query of the telecommunications installation

166 Wait

168 Reply

170 Status identical?

172 MV: =MV+1

174 Start Z2 (3 s)

192 Start Z3 (2 min)

194 Wait for event

196 Occupancy

198 Stop Z3

200 Process the occupancy

202 Z3 expired

### Drawing Translations

FIG. 3B

176 Wait for event

178 Occupancy

180 Stop Z2

182 Process the occupancy

184 Z2 expired

186 MV=2?

188 Set status in telecommunications installation

190 End

### Drawing Translations

FIG. 4A

12 Telecommunications installation

14 Workstation

220 M: Status query

221 Period M1 expired

222 M: Current status

224 No error: start period ml

226 In the event of error: start period m2

227 Period m2 expired

228 M: Status query

230 M: Current status

232 In the event of n errors after period m2: correction

FIG. 4B

12 Telecommunications installation

14 Workstation

162 Short-term monitoring Z1 expired

174 In the event of error: start period Z2

184 Period Z2 expired

250 M: Status query

252 M: Current status

254 No error: long-term monitoring

256 M: Status query

258 M: Current status

260 In the event of t errors after period Z2: correction

### Drawing Translations

FIG. 4C

12 Telecommunications installation

14 Workstation

192 No error: long-term monitoring

202 Long-term monitoring Z3 expired

270 M: Status query

272 M: Current status

274 In the event of error: start short-term monitoring

FIG. 4D

12 Telecommunications installation

14 Workstation

300 M: Status

302 Message monitoring Zr

306 Message monitoring Z4 expired: correction

1. A method for balancing the occupancy states between a terminal (14) and a switching facility (12),
in which a switching facility (12) connects a communication network and/or a data transmission network to at least one terminal (14) to which tasks are assigned by the switching facility (12),
the terminal (14) also processes tasks arriving from another place than the switching facility (12),
the terminal (14) is only able to perform a specified number of tasks simultaneously,
a change of the occupancy state of the terminal (14) occurs if the specified number is reached and not reached,
measures are initiated to note the change in the switching facility and/or in the terminal (14) if the occupancy state changes,
and in which the faultless execution of the measures is monitored automatically,
wherein the monitoring is carried out in the terminal (14).

2. The method as recited in claim 1,
wherein the monitoring is started as a function of the specified number not being reached.

3. The method as recited in claim 1 or 2, wherein the switching facility (12) distributes calls arriving under one number to one of several terminals (14, 16) or the switching facility (12) distributes messages arriving under one address to one of several terminals (14, 16).

4. The method as recited in one of the preceding claims,
wherein a first time period (Z1), which is preferably in the seconds range, is started (152) at the start of the monitoring,
if the terminal (14) is busy (156) during the first time period, the monitoring is interrupted,
and additional steps in connection with the monitoring, an error handling in particular, are carried out at the end (162) of the first time period.

5. The method as recited in claim 4,
wherein the occupancy state noted in the switching facility is transmitted (164) to the terminal (14) at the end (162) of the first time period (Z1),
the transmitted occupancy state is checked (170),
if the transmitted occupancy state deviates from the occupancy state of the terminal (14), additional steps in connection with the monitoring are carried out,
and if the transmitted occupancy state and the occupancy state of the terminal (14) agree, the monitoring is interrupted or additional steps are carried out in connection with the monitoring.

6. The method as recited in claim 5,
wherein error handling is started if the transmitted occupancy state deviates from the occupancy state of the terminal (14),
or the at least one second time period (Z2) is started (174), the second time period preferably being in the seconds range,
the monitoring is interrupted if the terminal (14) is occupied during the second time period (Z2),
and the error handling is carried out at the end of the second time period (Z2) or the last second time period (Z2).

7. The method as recited in claim 6,
wherein at the end of a second time period (Z2), which is not the last second time period (Z2), the occupancy state noted in the switching facility (12) is transmitted to the terminal,
the transmitted occupancy state is checked,
and the procedural steps referring to the result of the check are carried out according to one of claims 5 to 7.

8. The method as recited in one of claims 5 through 7,
wherein, if the transmitted state and the occupancy state of the terminal (14) agree, a third time period (Z3) is started (192), which is longer than the first time period (Z1) and preferably is in the minutes range,
if the terminal (14) is occupied (196) during the third time period, the monitoring is interrupted,
at the end (262) of the third time period, the occupancy state noted in the switching facility (12) is transmitted (174) to the terminal (14),
the transmitted occupancy state is checked (176),
and the procedural steps, which refer to the check result, are carried out according to one of claims 5 to 8.

9. The method as recited in one of the preceding claims,
wherein the actions to note the change in the switching facility (12) are repeated for the error handling,
or the occupancy state of the terminal (14) may be adapted to the occupancy state noted in the switching facility (12).

10. A terminal (14), a data processing system in particular,
having a port for connecting a switching facility (12), which connects the terminal (14) to a communication network and/or a data transmission network,
having a task processing unit which processes tasks assigned by the switching facility and tasks originating from another place than the switching facility,
the task processing unit being able to complete only a specified number of tasks simultaneously,
and the occupancy state of the terminal (14) being changed if the specified number is reached and not reached,
and having a monitoring unit that automatically monitors the actions to note the changes.

11. The terminal as recited in claim 10,
wherein the monitoring is started as a function of not reaching the specified number.

12. The terminal as recited in claim 10 or 11,
wherein it is configured in such a manner that a method as recited in one of claims 1 through 9 is carried out when it is operated.

13. A monitoring program having an instruction sequence such that when executed by a processor the procedural steps referring to the monitoring are carried out as recited in one of claims 1 through 9.
